(19) United States
(12) Patent Application Publication
(10) Pub. No.: US 2018/0335661 A1
(43) Pub. Date: Nov. 22, 2018

(54) APPARATUS AND METHOD FOR MANUFACTURING CLEANING SOLUTION

(71) Applicant: SEMES CO., LTD., Chungcheongnam-do (KR)

(72) Inventors: TAE-KEUN KIM, Gyeonggi-do (KR); JAEHYEOK YU, Chungcheongnam-do (KR); MINHEE CHO, Chungcheongnam-do (KR); SEHOON OH, Chungcheongnam-do (KR); HAE RIM OH, Gyeongsangnam-do (KR); JI SOO JEONG, Seoul (KR)

(21) Appl. No.: 15/980,807

(22) Filed: May 16, 2018

(30) Foreign Application Priority Data
May 17, 2017 (KR) 10-2017-0060916

(51) Int. Cl. G02F 1/1333; C11D 11/00; C11D 1/00; B08B 3/08

(52) U.S. Cl. CPC G02F 1/133305; C11D 11/0094; B08B 1/001; B08B 3/08; C11D 1/00

(57) ABSTRACT

Disclosed are an apparatus and a method for manufacturing a cleaning solution. The method includes mixing a surfactant chemical and pure water at a first temperature, and after the mixing of the surfactant chemical and the pure water at the first temperature, mixing the surfactant chemical and the pure water while cooling the surfactant chemical and the pure water to a second temperature that is lower than the first temperature.

### CROSS-REFERENCE TO RELATED APPLICATIONS

This application claims priority under 35 U.S.C. § 119 to Korean Patent Application No. 10-2017-0060916 filed on May 17, 2017, in the Korean Intellectual Property Office, the disclosures of which are incorporated by reference herein in their entireties.

### BACKGROUND

Embodiments of the inventive concept described herein relate to an apparatus and a method for manufacturing a cleaning solution.

Contaminants such as particles, organic contaminants, and metallic contaminants on a surface of a substrate greatly influence the characteristics and yield rate of a semiconductor device. Due to this, a cleaning process of removing various contaminants attached to a surface of a substrate is very important, and a process of cleaning a substrate is performed before and after unit processes for manufacturing a semiconductor. In general, a process of cleaning a substrate includes a cleaning solution treating process of removing metallic substances, organic substances, and particles residing on a substrate by using a treatment liquid such as a cleaning solution, a rinsing process of removing the cleaning solution residing on the substrate by using pure water, and a drying process of drying the substrate by using an organic solvent, a supercritical fluid, or a nitrogen gas.

The cleaning solution used in the above-mentioned cleaning solution processing process is manufactured by mixing the surfactant chemical containing a surfactant and the pure water. When the cleaning solution is manufactured by mixing the surfactant chemical and the pure water, particles are formed in the cleaning solution. The generated particles make it easy to remove particles when the substrate is cleaned. Generally, the surfactant chemical and the pure water are mixed at a room temperature.

### SUMMARY

Embodiments of the inventive concept provide an apparatus and a method for manufacturing a cleaning solution, by which the sizes of particles in a cleaning solution may be increased.

The inventive concept further provides an apparatus and a method for manufacturing a cleaning solution, by which a time for manufacturing a cleaning solution may be shortened.

The problems that are to be solved by the inventive concept are not limited to the above-mentioned problems, and the unmentioned problems will be clearly understood by those skilled in the art to which the inventive concept pertains from the specification and the accompanying drawings.

The inventive concept provides a method for manufacturing a cleaning solution that cleans a substrate. The method comprises mixing a surfactant chemical and pure water at a first temperature, and after the mixing of the surfactant chemical and the pure water at the first temperature, mixing the surfactant chemical and the pure water while cooling the surfactant chemical and the pure water to a second temperature that is lower than the first temperature.

The first temperature may be higher than a room temperature and the second temperature may be lower than the room temperature.

The first temperature may be lower than 30° C.

The first temperature may be higher than 25 ° C. and lower than 27° C., and the second temperature may be higher than 17° C. and lower than 19° C.

The first temperature may be maintained for a period of time that is longer than 25 minutes and shorter than 35 minutes.

The lengths of the particles formed in the cleaning solution may be not less than 30 μm.

The inventive concept provides an apparatus for manufacturing a cleaning solution. The apparatus comprises a housing having a liquid mixing space in the interior thereof, a first supply member configured to supply a surfactant chemical into the housing, a second supply member configured to supply pure water into the housing, a mixing unit configured to mix the surfactant chemical and the pure water supplied into the housing, a temperature adjusting member configured to adjust the temperatures of the surfactant chemical and the pure water supplied into the housing, and a controller configured to control the first supply member, the second supply member, the mixing unit, and the temperature adjusting member, and the controller controls the first supply member, the second supply member, the mixing unit, and the temperature adjusting member to perform a first operation of mixing the surfactant chemical and the pure water supplied into the liquid mixing space at a first temperature and a second operation of cooling the surfactant chemical and the pure water supplied into the liquid mixed in the first operation at a second temperature that is lower than the first temperature.

The first temperature may be higher than a room temperature and the second temperature may be lower than the room temperature.

The first temperature may be higher than 25° C. and lower than 27° C., and the second temperature may be higher than 17° C. and lower than 19° C.

The controller may control the temperature adjusting member such that the first temperature is maintained for a period of time that is longer than 25 minutes and shorter than 35 minutes.

The first operation may include a pure water supplying operation of supplying the pure water intro the liquid mixing space, a pure water heating operation of, after the pure water supplying operation, heating the pure water supplied into the liquid mixing space to the first temperature, a surfactant chemical supplying operation of, after the pure water heating operation, supplying the surfactant chemical into the liquid mixing space, and a mixing operation of, after the surfactant chemical supplying operation, mixing the surfactant chemical and the pure water supplied into the liquid mixing space while maintaining the surfactant chemical and the pure water at the first temperature.

The mixing unit may include a circulation line, through which a liquid supplied into the liquid mixing space flows and opposite ends of which is connected to the liquid mixing space, and a pump configured to provide power such that the liquid circulates in the circulation line.

A method for manufacturing a cleaning solution that cleans a substrate according to another embodiment of the inventive concept comprises a first operation of mixing a surfactant chemical and pure water at a first temperature, and the first temperature is higher than a room temperature and lower than 30° C.

The method may further include a second operation of mixing the surfactant chemical and the pure water mixed in the first operation while cooling the surfactant chemical and the pure water at a second temperature, and the second temperature may be lower than the first temperature.

The second temperature may be lower than a room temperature.

The first temperature may be higher than 25° C. and lower than 27° C., and the second temperature may be higher than 17° C. and lower than 19° C.

The first temperature may be maintained for a period of time that is longer than 25 minutes and shorter than 35 minutes.

The lengths of the particles formed in the cleaning solution may be not less than 30 μm.

### BRIEF DESCRIPTION OF THE FIGURES

The above and other objects and features of the inventive concept will become apparent by describing in detail exemplary embodiments thereof with reference to the accompanying drawings.

FIG. 1 is a plan view schematically illustrating an example of a substrate treating system 1 that uses a cleaning liquid manufactured according to an embodiment of the inventive concept;

FIG. 2 is a sectional view illustrating an example of the substrate treating apparatus 300 provided in the process chamber of FIG. 1;

FIG. 3 is a view schematically illustrating a cleaning solution manufacturing apparatus 400 according to an embodiment of the inventive concept; and

FIG. 4 is a flowchart illustrating a cleaning solution manufacturing method according to an embodiment of the inventive concept.

### DETAILED DESCRIPTION

Hereinafter, exemplary embodiments of the inventive concept will be described in more detail with reference to the accompanying drawings. The embodiments of the inventive concept may be modified in various forms, and the scope of the inventive concept should not be construed to be limited to the following embodiments. The embodiments of the inventive concept are provided to describe the inventive concept for those skilled in the art more completely. Accordingly, the shapes of the components of the drawings are exaggerated to emphasize clearer description thereof.

In the embodiments of the inventive concept, a substrate treating apparatus for performing a process of cleaning a substrate and a cleaning solution manufacturing apparatus for manufacturing a cleaning solution will be described. However, the inventive concept is not limited thereto, and may be applied to various types of apparatuses that clean a substrate by using a cleaning liquid.

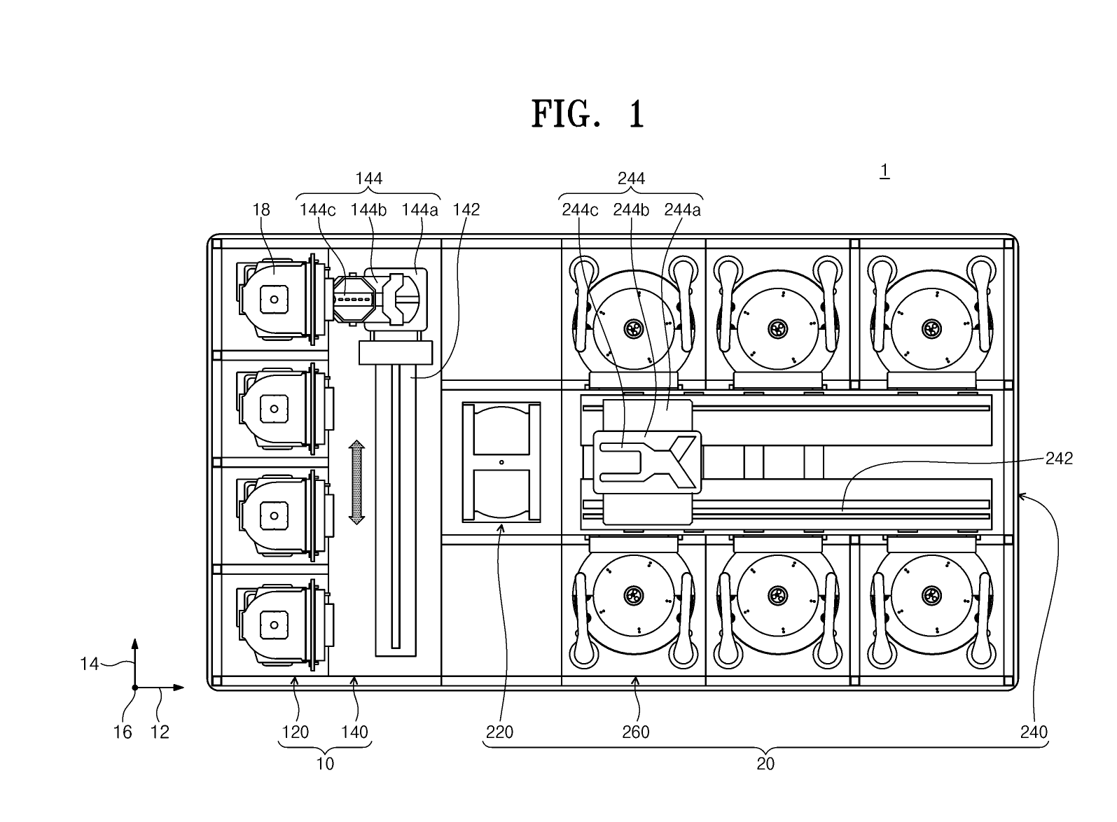

Hereinafter, exemplary embodiments of the inventive concept will be described with reference to FIGS. 1 to 4.

FIG. 1 is a plan view schematically illustrating an example of a substrate treating system 1 that uses a cleaning liquid manufactured according to an embodiment of the inventive concept.

Referring to FIG. 1, the substrate treating system 1 has an index module 10 and a process treating module 20, and the index module 10 has a plurality of load ports 120 and a feeding frame 140. The load ports 120, the feeding frame 140, and the process executing module 20 may be sequentially arranged in a row. Hereinafter, a direction in which the load port 120, the feeding frame 140, and the process treating module 20 will be referred to a first direction 12. A direction perpendicular to the first direction 12 when viewed from the top will be referred to as a second direction 14, and a direction normal to a plane including the first direction 12 and the second direction 14 will be referred to as a third direction 16.

A carrier 130, in which a substrate W is received, is seated on the load port 120. A plurality of load ports 120 are provided, and are disposed along the second direction 14 in a row. FIG. 1 illustrates that four load ports 120 are provided. The number of the load ports 120 may be increased or decreased according to the process efficiency of the process executing module 20, a footprint condition, and the like. A plurality of slots (not illustrated) provided to support peripheries of substrates W are formed in the carrier 130. A plurality of slots are provided along the third direction 16, and the substrate W is situated in the carrier 130 such that the substrates W are stacked to be spaced apart from each other along the third direction 16. A front opening unified pod (FOUP) may be used as the carrier 130.

The process treating module 20 includes a buffer unit 220, a feeding chamber 240, and a plurality of process chambers 260. The feeding chamber 240 is disposed such that the lengthwise direction thereof is in parallel to the first direction 12. The process chambers 260 are disposed on opposite sides of the feeding chamber 240 along the second direction 14. The process chambers 260 situated on one side of the feeding chamber 240 and the process chambers 260 situated on an opposite side of the feeding chamber 240 are symmetrical to each other with respect to the feeding chamber 240. Some of the process chambers 260 are disposed along the lengthwise direction of the feeding chamber 240. Furthermore, some of the process chambers 260 are disposed to be stacked on each other. That is, the process chambers 260 having an array of A×B (A and B are natural numbers) may be disposed on one side of the feeding chamber 240. Here, A is the number of the process chambers 260 provided in a row along the first direction 12, and B is the number of the process chambers 260 provided in a row along the third direction 16. When four or six process chambers 260 are provided on one side of the feeding chamber 240, the process chambers 260 may be arranged in an array of 2×2 or 3×2. The number of the process chambers 260 may increase or decrease. Unlike the above-mentioned description, the process chambers 260 may be provided only on one side of the feeding chamber 240. Further, unlike the above-mentioned description, the process chambers 260 may be provided on one side or opposite sides of the feeding chamber 240 to form a single layer.

A buffer unit 220 is disposed between the feeding frame 140 and the feeding chamber 240. The buffer unit 220 provides a space in which the substrates W stay before being transported, between the feeding chamber 240 and the feeding frame 140. Slots (not illustrated) in which the substrates W are positioned are provided in the buffer unit 220, and a plurality of slots (not illustrated) are provided to be spaced apart from each other along the third direction 16. Faces of the buffer unit 220 that faces the feeding frame 140 and faces the feeding chamber 240 are opened.

The feeding frame 140 transports the substrates W between the carrier 130 seated on the load port 120 and the buffer unit 220. An index rail 142 and an index robot 144 are provided in the feeding frame 140. The index rail 142 is provided such that the lengthwise direction thereof is in parallel to the second direction 14. The index robot 144 is installed on the index rail 142, and is linearly moved in the second direction 14 along the index rail 142. The index robot 144 has a base 144a, a body 144b, and a plurality of index arms 144c. The base 144a is installed to be moved along the index rail 142. The body 144b is coupled to the base 144a. The body 144b is provided to be moved along the third direction 16 on the base 144a. The body 144b is provided to be rotated on the base 144a. The index arms 144c are coupled to the body 144b, and are provided to be moved forwards and rearwards with respect to the body 144b. A plurality of index arms 144c are provided to be driven individually. The index arms 144c are disposed to be stacked so as to be spaced apart from each other along the third direction 16. Some of the index arms 144c are used when the substrates W are transported to the carrier 130 in the process treating module 20, and some of the index arms 144c may be used when the substrates W are transported from the carrier 130 to the process treating module 20. This structure may prevent particles generated from the substrates W before the process treatment from being attached to the substrates W after the process treatment in the process of carrying the substrates W in and out by the index robot 144.

The feeding chamber 240 transports the substrates W between the buffer unit 220 and the process chambers 260, and between the process chambers 260. A guide rail 242 and a main robot 244 are provided in the feeding chamber 240. The guide rail 242 is disposed such that the lengthwise direction thereof is in parallel to the first direction 12. The main robot 244 is installed on the guide rail 242, and is linearly moved along the first direction 12 on the index rail 242. The main robot 244 has a base 244a, a body 244b, and a plurality of main arms 244c. The base 244a is installed to be moved along the guide rail 242. The body 244b is coupled to the base 244a. The body 244b is provided to be moved along the third direction 16 on the base 244a. The body 244b is provided to be rotated on the base 244a. The main arms 244c are coupled to the body 244b, and are provided to be moved forwards and rearwards with respect to the body 244b. A plurality of main arms 244c are provided to be driven individually. The main arms 244c are disposed to be stacked so as to be spaced apart from each other along the third direction 16. The main arms 244c used when the substrates W are transported from the buffer unit 220 to the process chambers 260 and the main arms 244 used when the substrates W are transported from the process chambers 260 to the buffer unit 220 may be different.

Substrate treating apparatuses 300 that perform cleaning processes on the substrates W are provided in the process chambers 260. The substrate treating apparatuses 300 provided in the process chambers 260 may have different structures according to the types of performed cleaning processes. Selectively, the substrate treating apparatuses 300 in the process chambers 260 may have the same structure. Selectively, the process chambers 260 may be classified into a plurality of groups such that the substrate treating apparatuses 300 provided in the process chambers 260 pertaining to the same group have the same structure and the substrate treating apparatuses 300 provided in the process chambers 260 pertaining to different groups has different structures. For example, when the process chambers 260 are classified into two groups, the first group of process chambers 260 may be provided on one side of the feeding chamber 240 and the second group of process chambers 260 may be provided on an opposite side of the feeding chamber 240. Selectively, the first group of process chambers 260 may be provided on the lower side of the feeding chamber 240 and the second group of process chambers 260 may be provided on the upper side of the feeding chamber 240, on opposite sides of the feeding chamber 240. The first group of process chambers 260 and the second group of process chambers 260 may be classified according to the kinds of the used chemicals or the types of cleaning methods.

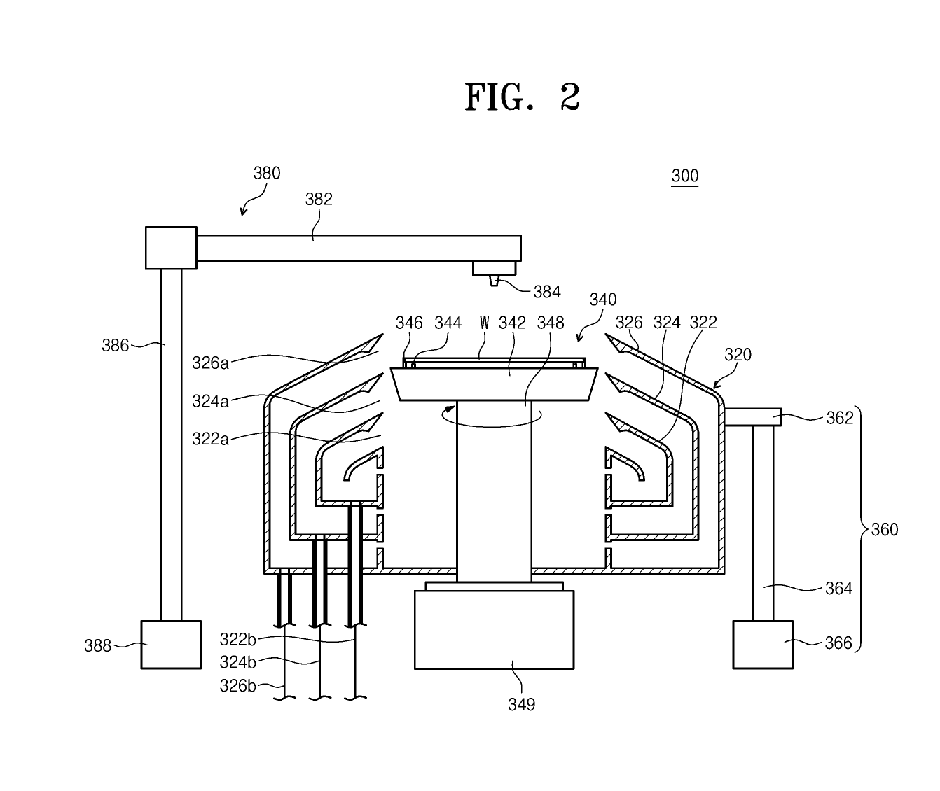

Hereinafter, an example of a substrate treating apparatus 300 that cleans a substrate W by using a treatment liquid will be described. FIG. 2 is a sectional view illustrating an example of the substrate treating apparatus 300 provided in the process chamber of FIG. 1. Referring to FIG. 2, the substrate treating apparatus 300 includes a housing 320, a support unit 340, and an ejection unit 380.

The housing 320 provides a space for performing a substrate treating process, and an upper side of the housing 320 is opened. The housing 320 has an inner recovery vessel 322, an intermediate recovery vessel 324, and an outer recovery vessel 326. The recovery vessels 322, 324, and 326 recover different treatment liquids used in the process. The inner recovery vessel 322 has an annular ring shape that surrounds the spin head 340, the intermediate recovery vessel 324 has an annular ring shape that surrounds the inner recovery vessel 322, and the outer recovery vessel 326 has an annular ring shape that surrounds the intermediate recovery vessel 324. An inner space 322a of the inner recovery vessel 322, a space 324a between the inner recovery vessel 322 and the intermediate recovery vessel 324, and a space 326a between the intermediate recovery vessel 324 and the outer recovery vessel 326 function as inlets through which the treatment liquids are introduced into the inner recovery vessel 322, the intermediate recovery vessel 324, and the outer recovery vessel 326. Recovery lines 322b, 324b, and 326b extending from the recovery vessels 322, 324, and 326 perpendicularly in the downward direction of the bottom surfaces thereof are connected to the recovery vessels 322, 324, and 326, respectively. The recovery lines 322b, 324b, and 326b discharge the treatment liquids introduced through the recovery vessels 322, 324, 326, respectively. The discharged treatment liquids may be reused through an external treatment liquid recycling system (not illustrated).

The support unit is provided within the housing. A substrate W is positioned on the support unit. The support unit may be provided to the spin head 340. According to an embodiment, the spin head 340 is arranged within the housing 320. The spin head 340 supports and rotates the substrate W during the process. The spin head 340 has a body 342, a plurality of support pins 334, a plurality of chuck pins 346, and a support shaft 348. The body 342 has an upper surface having a substantially circular shape when viewed from the top. The support shaft 348 that may be rotated by a motor 349 is fixedly coupled to the bottom of the body 342. A plurality of support pins 334 are provided. The support pins 334 may be arranged to be spaced apart from each other at a periphery of the upper surface of the body 342 by a specific interval and protrude upwards from the body 342. The support pins 334 are arranged to have a generally annular ring shape through combination thereof. The support pins 334 support a periphery of a rear surface of the substrate W such that the substrate W is spaced apart from the upper surface of the body 342 by a predetermined distance. A plurality of chuck pins 346 are provided. The chuck pins 346 are disposed to be more distant from the center of the body 342 than the support pins 334. The chuck pins 346 are provided to protrude upwards from the body 342. The chuck pins 346 support a side of the substrate W such that the substrate W is not separated laterally from a proper place when the spin head 340 is rotated. The chuck pins 346 are provided to be linearly moved between a standby position and a support position along a radial direction of the body 342. The standby position is a position that is more distant from the center of the body 342 than the support position. When the substrate W is loaded on or unloaded from the spin head 340, the chuck pins 346 are located at the standby position, and when a process is performed on the substrate W, the chuck pins 346 are located at the support position. The chuck pins 346 are in contact with the side of the substrate W at the support position.

The elevation unit 360 linearly moves the housing 320 upwards and downwards. When the housing 320 moves upwards and downwards, a relative height of the housing 320 to the spin head 340 is changed. The elevation unit 360 has a bracket 362, a movable shaft 364, and a driver 366. The bracket 362 is fixedly installed on an outer wall of the housing 320, and the movable shaft 364 that moves upwards and downwards by the driver 366 is fixedly coupled to the bracket 362. The housing 320 is lowered such that, when the substrate W is positioned on the spin head 340 or is lifted from the spin head 340, the housing 320 is lowered such that the spin head 340 protrudes to the upper side of the housing 320. When the process is performed, the height of the housing 320 is adjusted such that the treatment liquid are introduced into the preset recovery vessel 360 according to the kind of the treatment liquid supplied to the substrate W. For example, while a first treatment liquid, a second treatment liquid, and a third treatment liquid, which are different from each other, are supplied to the substrate, the substrate w is located at a height corresponding to the inner space 322a of the inner recovery vessel 322. Further, the substrate W may be located at a height corresponding to a space 324a between the inner recovery vessel 322 and the intermediate recovery vessel 324 and a space 326a between the intermediate recovery vessel 324 and the outer recovery vessel 3265 while the substrate W is treated by a second treatment liquid and a third treatment liquid. Unlike those described above, the elevation unit 360 may move the spin head 340, instead of the housing 320, upwards and downwards.

The ejection member 380 supplies a liquid to the substrate W during a substrate treating process. The ejection member 380 has a nozzle support 382, a nozzle 384, a support shaft 386, and a driver 388. The lengthwise direction of the support shaft 386 is provided along the third direction 16, and the driver 388 is coupled to a lower end of the support shaft 386. The driver 388 rotates and elevates the support shaft 386. The nozzle support 382 is coupled to an end of the support shaft 386, which is opposite to an end of the support shaft 386 coupled to the driver 388, perpendicularly to the support 386. The nozzle 384 is installed on a bottom surface of an end of the nozzle support 382. The nozzle 384 is moved to a process location and a standby location by the driver 388. The process location is a location at which the nozzle 384 is arranged at a vertical upper portion of the housing 320, and the standby location is a location that deviates from the vertical upper portion of the housing 320. One or a plurality of ejection members 380 may be provided. When a plurality of ejection members 380 are provided, different liquid may be ejected.

The nozzle 384 supplies a cleaning solution that is one of the treatment liquids used in the substrate treating apparatus 300 to the substrate W positioned on the spin head 340. According to an embodiment of the inventive concept, the cleaning solution is manufactured by mixing a surfactant chemical containing a surfactant and pure water. A chemical of ‘SAP 1.0’ of ‘Dong-Woo Fine Chemistry Inc.’ is provided as the surfactant chemical. Unlike this, if the surfactant chemical contains a surfactant and is mixed with pure water, various kinds of chemicals that form particles may be provided.

Hereinafter, a cleaning solution manufacturing apparatus according to an embodiment of the inventive concept will be described.

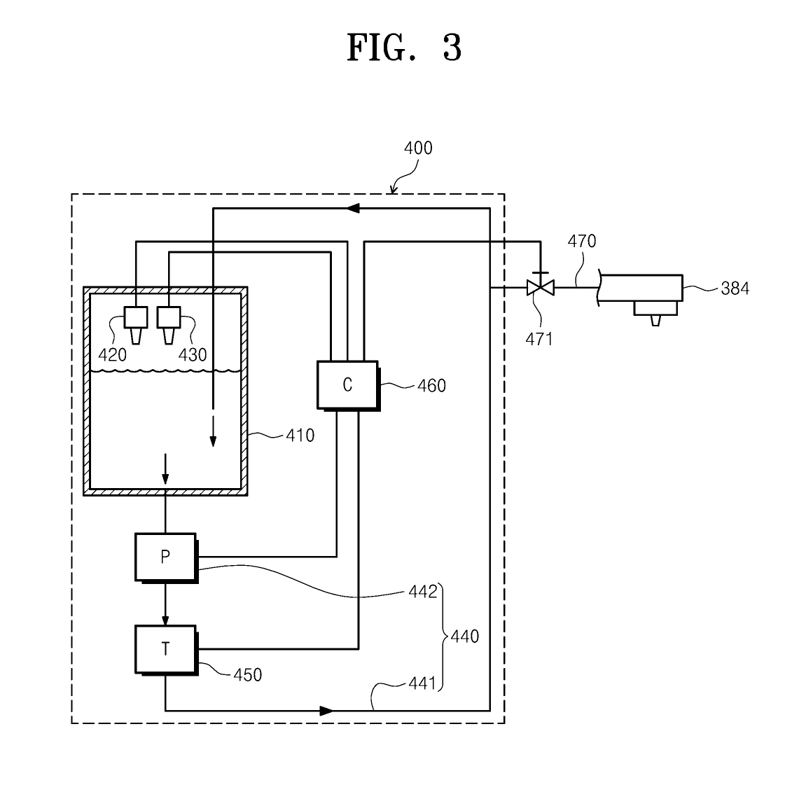

FIG. 3 is a view schematically illustrating a cleaning solution manufacturing apparatus 400 according to an embodiment of the inventive concept.

Referring to FIG. 3, the cleaning solution manufacturing apparatus 400 manufactures a cleaning solution that cleans a substrate. The cleaning solution manufacturing apparatus 400 includes a housing 410, a first supply member 420, a second supply member 430, a mixing unit 440, a temperature adjusting member 450, and a controller 460.

The housing 410 has a liquid mixing space in which liquids supplied into the interior thereof are mixed. A wall of the housing 410 may be insulated in order that heat exchange of the housing 410 with the outside may be minimized so that the temperature of the liquid supplied into the liquid mixing space may be easily adjusted. The housing 410 may be provided with a temperature sensor that measures the temperature of the liquids in the liquid mixing space. The temperature of the liquids measured by the temperature sensor is delivered to the controller 460.

The first supply member 420 supplies a surfactant chemical into the liquid mixing space, and the second supply member 430 supplies pure water into the liquid mixing space.

The mixing unit 440 mixes the surfactant chemical and the pure water supplied into the liquid mixing space. According to an embodiment, the mixing unit 440 includes a circulation line 441 and a pump 442.

Opposite ends of the circulation line 441 are connected to the liquid mixing space, and the liquids supplied into the liquid mixing space flows in the circulation line 441. The circulation line 441 may be insulated such that heat exchange between the interior and exterior of the circulation line 441 may be minimized. According to an embodiment, the supply line 470 connected to the nozzle 384 is connected to the circulation line 441. An opening/closing valve 471 is provided in the circulation line 441.

The pump 442 provides power such that the liquid in the liquid mixing space circulates in the circulation line 441.

The mixing unit 440 mixes the surfactant chemical and the pure water supplied into the liquid mixing space by circulating the surfactant chemical and the pure water into the liquid mixing space again via the circulation line 441.

The temperature adjusting member 450 adjusts the temperatures of the surfactant chemical and the pure water supplied into the liquid mixing space. According to an embodiment, the temperature adjusting member 450 may be provided outside the housing 410. For example, the temperature adjusting member 450 may be connected to the circulation line 441 such that the temperature of the liquids flowing in the circulation line 441 may be adjusted. Unlike this, the temperature adjusting member 450 may be installed in the housing 410 to directly adjust the temperature of the liquids staying in the liquid mixing space. The temperature adjusting member 450 may include various kinds of members that may heat and cool the surfactant chemical and the pure water supplied into the liquid mixing space. For example, the temperature adjusting member 450 may include a heating line that generates heat with currents supplied to heat the surfactant chemical and the pure water or a thermal fluid passage, through which a thermal fluid flows. Further, the temperature adjusting member 450 may include a cooling passage, through which a thermoelectric element or a cooling fluid for cooling the surfactant chemical and the pure water. The temperature adjusting member 450 may be provided with a temperature sensor that measures the temperatures of the surfactant chemical and the pure water that passes through the interior of the temperature adjusting member 450. The temperatures of the liquids measured by the temperature sensor are delivered to the controller 460.

The controller 460 controls the first supply member 420, the second supply member 430, the mixing unit 440, the temperature adjusting member 450, and the opening/closing valve 471 to manufacture the cleaning solution according to the cleaning solution manufacturing method that will be described below.

Hereinafter, the cleaning solution manufacturing method according to the embodiment of the inventive concept will be described by using the cleaning solution manufacturing apparatus 400 of FIG. 3. In the cleaning solution manufacturing method, a cleaning solution that cleans a substrate is manufactured.

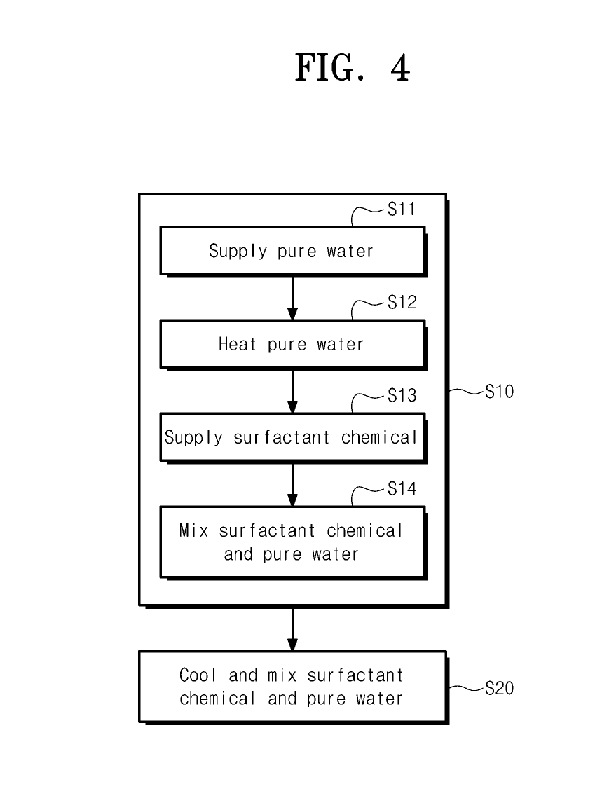

FIG. 4 is a flowchart illustrating a cleaning solution manufacturing method according to an embodiment of the inventive concept.

Referring to FIGS. 3 and 4, the cleaning solution manufacturing method includes a first operation (S10) and a second operation (S20).

In the first operation (S10), a surfactant chemical and pure water are mixed at a first temperature. According to an embodiment, in the first operation (S10), the controller 460 controls the first supply member 420, the second supply member 430, the mixing unit 440, and the temperature adjusting member 450 such that the surfactant chemical and the pure water supplied into the liquid mixing space of the housing 410 are mixed at a first temperature. The first temperature is a temperature that is higher than a room temperature and lower than 30° C. According to an embodiment, preferably, the first temperature is a temperature that is higher than 25° C. and lower than 27° C. For example, the first temperature is 26.5° C. The sizes of the particles formed in the cleaning solution may be made large as compared with a general mixing method of mixing the surfactant chemical and the pure water at a room temperature, by mixing general mixing method of mixing at a temperature that is higher than a room temperature.

According to an embodiment, the first operation (S10) includes a pure water supplying operation (S11), a pure water heating operation (S12), a surfactant chemical supplying operation (S13), and a mixing operation (S14).

In the pure water supplying operation (S11), the controller 460 controls the second supply member 430 to supply the pure water into the liquid mixing space of the housing 410.

Thereafter, the pure water heating operation (S12) is performed. In the pure water heating operation (S12), the pure water supplied into the liquid mixing space is heated to the first temperature. According to an embodiment, in the pure water heating operation (S12), the controller 460 controls the pump 442 and the temperature adjusting member 450 to heat the pure water supplied into the liquid mixing space to the first temperature while the pure water circulating in the circulation line 441.

Thereafter, the surfactant chemical supplying operation (S13) is performed. In the surfactant chemical supplying operation (S13), the surfactant chemical is supplied into the liquid mixing space of the housing 410. According to an embodiment, in the surfactant chemical supplying operation (S13), the controller 460 controls the first supply member 420 to supply the surfactant chemical into the liquid mixing space of the housing 410. While the pure water is supplied into the liquid mixing space, the controller 460 controls the temperature adjusting member 450 and the pump 442 to circulate the surfactant chemical and the pure water in the housing 410 in the circulation line 441 while the surfactant chemical and the pure water are maintained at the first temperature.

Thereafter, the mixing operation (S14) is performed. In the mixing operation (S14), the surfactant chemical and the pure water supplied into the liquid mixing space of the housing 410 are mixed while being maintained at the first temperature. According to an embodiment, the mixing operation (S14), the controller 460 controls the temperature adjusting member 450 and the pump 442 to circulate the surfactant chemical and the pure water in the liquid mixing space in the circulation line 441 while the surfactant chemical and the pure water are maintained at the first temperature. The surfactant chemical and the pure water are mixed while circulating in the circulation line 441. The mixing operation (S14) is performed for a predetermined period of time. According to an embodiment, the mixing operation (S14) is performed for a period of time that is longer than 25 minutes and shorter than 35 minutes.

In the second operation (S20), the surfactant chemical and the pure water mixed in the first operation are mixed while being cooled to a second temperature. According to an embodiment, in the second operation (S20), the controller 460 controls the temperature adjusting member 450 and the pump 442 to circulate the surfactant chemical and the pure water mixed in the first operation (S10) in the circulation line 441 while the surfactant chemical and the pure water are cooled to the second temperature that is lower than a room temperature. According to an embodiment, preferably, the second temperature is a temperature that is higher than 17° C. and lower than 19° C. For example, the second temperature is 18° C.

When the second operation (S20) is completed and the manufacturing of the cleaning solution is completed, the controller 460 controls the opening/closing valve 471 such that the opening/closing valve 471 may be opened and closed to supply the cleaning solution in the circulation line 441 to the nozzle 384. While the first operation (S10) and the second operation (S20) are performed, the controller 460 controls the opening/closing valve 471 such that the opening/closing valve 471 may be closed. As described above, by mixing the surfactant chemical and the pure water at the second temperature after mixing the surfactant chemical and the pure water at the first temperature, the sizes of the particles in the cleaning solution may be made large and the time for forming the particles to the same size may be shortened as compared with the case in which the surfactant chemical and the pure water are mixed only at the first temperature. For example, the lengths of the particles in the cleaning solution may be made not less than 30 μm by the apparatus and the method of the inventive concept. That is, when the particles have rectangular plate shapes, the lengths of the long sides of the particles may be not less than 30 μm.

According to the embodiments of the inventive concept, the sizes of the particles in the cleaning solution may be increased.

Further, according to the embodiments of the inventive concept, the time for manufacturing g the cleaning solution may be shortened.

While the inventive concept has been described with reference to exemplary embodiments thereof, it will be apparent to those of ordinary skill in the art that various changes and modifications may be made thereto without departing from the spirit and scope of the inventive concept as set forth in the following claims.

What is claimed is:

1. A method for manufacturing a cleaning solution that cleans a substrate, the method comprising:
mixing a surfactant chemical and pure water at a first temperature; and
after the mixing of the surfactant chemical and the pure water at the first temperature, mixing the surfactant chemical and the pure water while cooling the surfactant chemical and the pure water to a second temperature that is lower than the first temperature.

2. The method of claim 1, wherein the first temperature is higher than a room temperature and the second temperature is lower than the room temperature.

3. The method of claim 1, wherein the first temperature is lower than 30° C.

4. The method of claim 1, wherein the first temperature is higher than 25° C. and lower than 27° C., and the second temperature is higher than 17° C. and lower than 19° C.

5. The method of claim 4, wherein the first temperature is maintained for a period of time that is longer than 25 minutes and shorter than 35 minutes.

6. The method of claim 1, wherein the lengths of the particles formed in the cleaning solution is not less than 30 μm.

7. An apparatus for manufacturing a cleaning solution, the apparatus comprising:
a housing having a liquid mixing space in the interior thereof;
a first supply member configured to supply a surfactant chemical into the housing;
a second supply member configured to supply pure water into the housing;
a mixing unit configured to mix the surfactant chemical and the pure water supplied into the housing;
a temperature adjusting member configured to adjust the temperatures of the surfactant chemical and the pure water supplied into the housing; and
a controller configured to control the first supply member, the second supply member, the mixing unit, and the temperature adjusting member,
wherein the controller controls the first supply member, the second supply member, the mixing unit, and the temperature adjusting member to perform a first operation of mixing the surfactant chemical and the pure water supplied into the liquid mixing space at a first temperature and a second operation of cooling the surfactant chemical and the pure water supplied into the liquid mixed in the first operation at a second temperature that is lower than the first temperature.

8. The apparatus of claim 7, wherein the first temperature is higher than a room temperature and the second temperature is lower than the room temperature.

9. The apparatus of claim 7, wherein the first temperature is higher than 25° C. and lower than 27° C. , and the second temperature is higher than 17° C. and lower than 19° C.

10. The apparatus of claim 7, wherein the controller controls the temperature adjusting member such that the first temperature is maintained for a period of time that is longer than 25 minutes and shorter than 35 minutes.

11. The apparatus of claim 7, wherein the first operation comprises:
a pure water supplying operation of supplying the pure water intro the liquid mixing space;
a pure water heating operation of, after the pure water supplying operation, heating the pure water supplied into the liquid mixing space to the first temperature;
a surfactant chemical supplying operation of, after the pure water heating operation, supplying the surfactant chemical into the liquid mixing space; and
a mixing operation of, after the surfactant chemical supplying operation, mixing the surfactant chemical and the pure water supplied into the liquid mixing space while maintaining the surfactant chemical and the pure water at the first temperature.

12. The apparatus of claim 11, wherein the mixing unit comprises:
a circulation line, through which a liquid supplied into the liquid mixing space flows and opposite ends of which is connected to the liquid mixing space; and
a pump configured to provide power such that the liquid circulates in the circulation line.

13. A method for manufacturing a cleaning solution that cleans a substrate, the method comprising:
a first operation of mixing a surfactant chemical and pure water at a first temperature,
wherein the first temperature is higher than a room temperature.

14. The method of claim 13, wherein the first temperature is lower than 30° C.

15. The method of claim 14, further comprising:
a second operation of mixing the surfactant chemical and the pure water mixed in the first operation while cooling the surfactant chemical and the pure water at a second temperature,
wherein the second temperature is lower than the first temperature.

16. The method of claim 15, wherein the second temperature is lower than a room temperature.

17. The method of claim 15, wherein the first temperature is higher than 25° C. and lower than 27° C., and the second temperature is higher than 17° C. and lower than 19° C.

18. The method of claim 17, wherein the first temperature is maintained for a period of time that is longer than 25 minutes and shorter than 35 minutes.

19. The method of claim 15, wherein the lengths of the particles formed in the cleaning solution is not less than 30 μm.
